(19) United States
(12) Patent Application Publication
(10) Pub. No.: US 2026/0165467 A1
(43) Pub. Date: Jun. 18, 2026

(54) FOLDABLE SHELVING UNIT

(71) Applicant: WERNER CO., Itasca, IL (US)

(72) Inventors: Fairlyte P. Eubank, Mooresville, NC (US); Juan Aviles Quintero, El Paso, TX (US); Sherwin P. Galang, Bataan (PH)

(21) Appl. No.: 19/415,380

(22) Filed: Dec. 10, 2025

Related U.S. Application Data
(60) Provisional application No. 63/733,720, filed on Dec. 13, 2024.

(51) Int. Cl. A47B 43/00; B60R 7/08

(52) U.S. Cl. CPC A47B 43/00; B60R 7/08

(57) ABSTRACT

A foldable shelving unit including a shelf and at least one support unit to secure the shelf to a support beam. A bracket including a first end secured to the shelf and a second end secured to a spring, a hinge coupled to the shelf, and a pivot block. The pivot block includes a first securing portion configured to be secured to the spring, a second securing portion configured to be secured to the support beam, and a pivot point. The spring is configured to facilitate the shelf pivoting at the pivot point between a first position and a second position. The shelf is configured to rest on the pivot block when the shelf is in the first position.

### CROSS-REFERENCE TO RELATED APPLICATIONS

This application claims priority to U.S. Provisional Patent Application No. 63/733,720, filed Dec. 13, 2024, the entire contents of all of which are incorporated herein by reference.

### TECHNICAL FIELD

This disclosure relates generally to shelving units, and more particularly to a foldable shelving unit for use in a vehicle.

### BACKGROUND

Shelving systems for vehicles traditionally comprised stationary shelves, however, more recently, foldable shelves have been used that are movable between stowed and use positions, to allow for more flexibility with storage options within the vehicle. The foldable shelving systems may be provided in varying arrangements to further add flexibility to the utility of the shelving systems and the vehicle in which the shelving system is installed.

Foldable shelving systems may use a spring mechanism to move shelves between stowed and use positions. Many of these springs are coupled directly to a vertical support structure or directly to the vehicle, making installation difficult. Additionally, when a shelf is in use, the shelf load creates pressure on the spring causing frequent damage to the spring. Moreover, the springs are often damaged from debris

Further, current technologies provide foldable shelving systems that have a plurality of folding shelves but no easy way of moving objects from one shelf to another adjacent shelf without picking up an object and physically moving it to another (e.g., sometimes adjacent) shelf.

### SUMMARY

In some aspects, the techniques described herein relate to a foldable shelving unit including: a shelf having a top surface and a bottom surface; and at least one support unit to secure the shelf to a support beam, wherein the at least one support unit includes: a bracket including a first end secured to the shelf and a second end secured to a spring, a hinge coupled to at least one of the bottom surface of the shelf, and a pivot block, wherein the pivot block includes: a body having a first end, a second end, and a top surface, a first securing portion coupled to the first end of the pivot block, the first securing portion configured to be secured to the spring, a second securing portion coupled to the second end of the pivot block, the second securing portion configured to be secured to the support beam, and a pivot point located within the body, wherein the hinge is secured to the bottom surface of the shelf and to the pivot point of the pivot block, wherein the spring is configured to facilitate the shelf pivoting at the pivot point between a first position and a second position, wherein at least a portion of the bottom surface of the shelf is configured to rest on the top surface of the body of the pivot block when the shelf is in the first position.

In some aspects, the techniques described herein relate to a foldable shelving unit including: a support beam; a shelf attached to the support beam and including a support surface; at least one support unit to secure the shelf to the support beam, wherein the at least one support unit includes: a spring configured to facilitate movement of the shelf between a first position and a second position, a bracket including a first end secured to the shelf and a second end secured to the spring, a hinge coupled to the shelf, and a pivot block including a first end secured to the spring, a second end secured to the support beam, and a pivot point configured to connect the pivot block to the hinge; and an end cap removably couplable to the shelf in a first position in which at least a portion of the end cap projects above the support surface and a second position in which the end cap is stored below the support surface, wherein the hinge is pivotable about the pivot point to move the shelf between the first position and the second position.

In some aspects, the techniques described herein relate to a foldable shelving unit including: a support beam; a shelf attached to the support beam and including a support surface; at least one support unit to secure the shelf to the support beam, wherein the at least one support unit includes: an over-center spring configured to facilitate movement of the shelf between a first position and a second position and including a first end and a second end, a bracket including a first end secured to the shelf and a second end secured to the first end of the over-center spring, a hinge coupled to the shelf, and a pivot block including a first end secured to the second end of the over-center spring, a second end secured to the support beam, and a pivot point positioned between the first end of the pivot block and the second end of the pivot block configured to connect the pivot block to the hinge; and wherein the hinge is pivotable about the pivot point to move the shelf between the first position and the second position.

### BRIEF DESCRIPTION OF THE FIGURES

The above, as well as additional, features will be better understood through the following illustrative and non-limiting detailed description of example embodiments, with reference to the appended drawings.

FIG. 1A is a right isometric view of a foldable shelving unit of the present disclosure, the foldable shelving unit including a first shelf with a removable end cap and a support unit shown in a use position and a second shelf with a removable end cap and a support unit shown in a stowed position;

FIG. 1B is a left isometric view of the foldable shelving unit of FIG. 1A with the first shelf and the second shelf in use positions;

FIG. 2 is a left isometric view of the second shelf of FIG. 1A without the removable end cap and with a cover in the use position;

FIG. 3 is a left isometric view of a shelf of FIG. 1A with a support unit, without a cover and with the removable end cap, and the second shelf is shown in a position between the stowed position and the use position;

4A is a left isometric view of a pivot block of the support unit shown in FIG. 1A;

FIG. 4B is a left plan view of the pivot block of FIG. 4A;

FIG. 5A is a rear isometric view of another implementation of a pivot block for use with the support unit shown in FIG. 1A;

FIG. 5B is a left plan view of the pivot block of FIG. 5A;

FIG. 6 is an isometric view of a bracket of the support unit of FIG. 1A;

FIG. 7 is an isometric view of a hinge of the support unit of FIG. 1A;

FIG. 8 is an isometric view of an optional cover of the support unit of FIG. 1A;

FIG. 9A is an isometric view of the foldable shelving unit of FIG. 1A with at least one removable end cap in use between a pair of shelves;

FIG. 9B is an isometric view of the foldable shelving unit of FIG. 1A with a pair of removable end caps in use between the pair of shelves of FIG. 9A;

FIG. 9C is an isometric view of the foldable shelving unit of FIG. 1A without removable end caps between the pair of shelves of FIG. 9B;

FIG. 9D is an isometric view of a (e.g., right) end cap for use with at least one shelf of FIG. 1A;

FIG. 9E is an isometric view of a (e.g., left) end cap for use with at least one shelf of FIG. 1A;

FIG. 9F is an isometric view of a (e.g., left) end cap stored (e.g., not in use) on at least one shelf of FIG. 1A; and

FIG. 9G is an isometric view of a (e.g., left) end cap stored (e.g., not in use) on at least one shelf of FIG. 1A.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

The present disclosure provides a foldable shelving system that is designed for easier assembly, has better longevity, and enables objects on shelves to be moved from one shelf to the next without having to pick up the object.

A foldable shelving unit with a support unit having a pivot block and removable end caps are disclosed. In one embodiment, the foldable shelving unit has a support unit and a shelf. The support unit has a pivot block that attaches to a vertical support beam or upright which may be located within a vehicle. The pivot block includes at least one mounting feature that is secured to the vertical beam. The pivot block provides a pivot point so that the shelf is supported in both horizontal (e.g., in use) and vertical (e.g., stowed) positions and is free to rotate between the two positions. The pivot block also provides a fastening location for a spring, such as a gas spring. The spring attaches to the shelf or a bracket of the support unit, to assist in the movement of the shelf between the vertical and horizontal positions. A cover may be provided to protect the spring from debris or damage. The pivot block of the support unit includes a top surface that transfers the shelf load into the vertical support beam and is designed to handle heavy loads that will be seen in parcel or object delivery applications.

The foldable shelving unit may also include at least one removable end cap fastened to at least a portion of the shelf, near or adjacent, an edge of the shelf. The removable end cap may be installed in afirst position (e.g., use position) to prevent objects from sliding off the shelf and may be installed in a second position (e.g., storage position) or uninstalled to enable objects to easily slide from one shelf to (e.g., another substantially) adjacent shelf. The removable end cap may be installed and uninstalled by hand with fastening mechanisms or hardware. When the removable end cap is uninstalled, the removable end cap and hardware may be stored within, adjacent, or near at least one shelf to prevent loss or misplacement of the end cap or the end cap hardware.

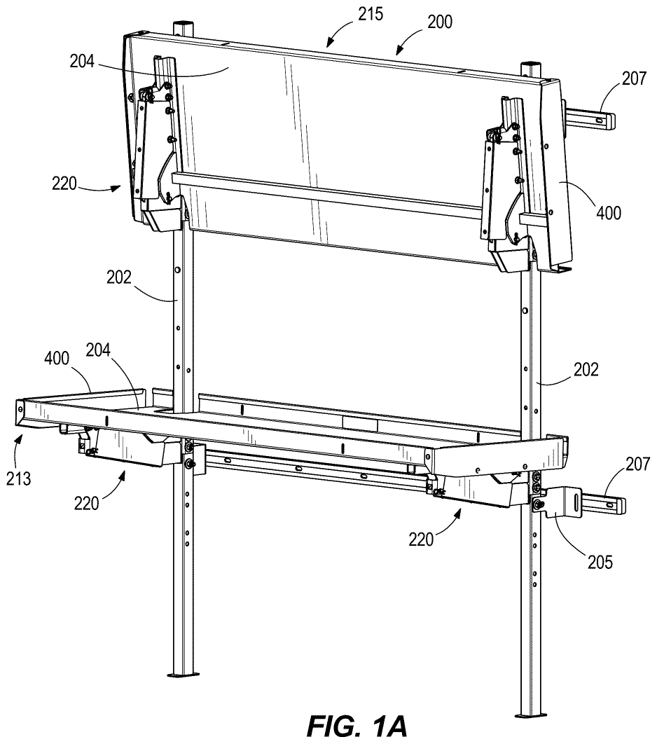

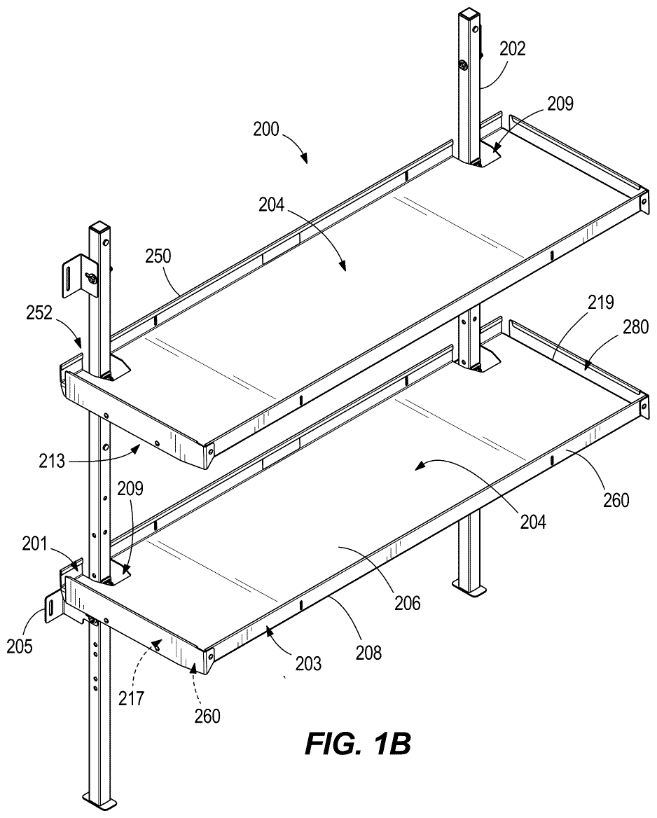

FIGS. 1A, 1B, 2, and 3 show an implementation of a foldable shelving unit 200 of the present disclosure. The foldable shelving unit 200 may include at least one shelf 204 with at least one support unit 220 and an optional removable end cap 400.

The shelf 204 is attached to a support beam or stanchion 202 with at least one support unit 220, wherein each support unit 220 is (e.g., axially) aligned with at least one support beam 202. The support beam 202 may be hollow and may be made of steel or another suitable material. In one example, the support beam 202 is secured to an interior wall, ceiling, or floor of a vehicle, such as a van or truck. In another example, the support beam 202 may be coupled to at least one mounting rail 207 with at least one mounting bracket 205, such that the mounting rail 207 may be secured to the interior wall of the vehicle.

The shelf 204 of the foldable shelving unit 200 is configured to move from a first unfolded, substantially horizontal position (or use position) 213, as shown in FIGS. 1A and 1B, to a second, folded substantially vertical position (or stowed position) 215, as shown in FIG. 1A.

The shelf 204 may have a substantially rectangular shape (or another suitable shape) with a first end 201 positioned near or adjacent the support beam 202 and may have a second end 203 opposite the first end 201. The first end 201 has at least one notch 209 (shown best in FIG. 1B) to accommodate the support beam 202 when the shelf 204 is in both the use position 213 and the stowed position 215. Although the notch 209 is shown as having a u-shape, it should be understood that the notch may be provided in other suitable shapes.

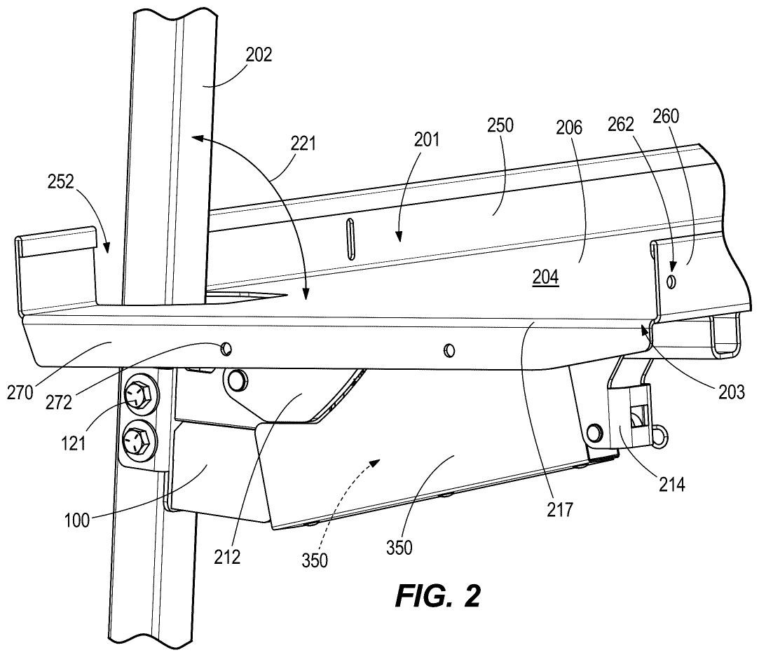

Additionally, as shown in FIG. 2, the first end 201 may include a first (or rear) flange 250 and the second end 203 may include a second (or front) flange 260 to facilitate storing various objects on the shelf 204 and to facilitate preventing objects from sliding off the shelf 204 when the shelf 204 is in use. The first flange 250 may extend a distance vertically upward from the shelf 204. Also, the first flange 250 may have a substantially uniform width and at least one notch 252 designed to accommodate the support beam 202 when the shelf 204 is in both the use position 213 and the stowed position 215. Moreover, the second flange 260 may extend a distance vertically upward from the shelf 204. The second flange 260 may have a substantially uniform width and at least one aperture (e.g., opening) 262 designed to receive a fastening mechanism therein to facilitate coupling at least one removable end cap 400 (discussed herein) to the shelf 204.

The shelf 204 further includes a top surface 206 (e.g., a support surface) upon which objects can rest when the shelf is in the use position, and a bottom surface 208 opposite the top surface.

The shelf 204 also includes a first edge (or left edge) 217 extending between the first end 201 and the second end 203, and further includes a second edge (or right edge) 219 opposite the first edge 217, such that the second edge 219 also extends between the first end 201 and the second end 203. The first edge 217 and/or the second edge 219 may be configured to accommodate at least one removable end cap 400. Specifically, the first edge 217 may have a projection 270 that extends vertically downward and having a width. The projection 270 has at least one aperture (e.g., opening) 272 designed to receive a fastening mechanism therein. The second edge 219 also may have a projection 280 that extends vertically downward. The projection 280 has a width and has at least one opening (not shown) designed to receive a fastening mechanism therein. In some embodiments, both the width of the projection 270 of the first edge 217 and the width of the projection 280 of the second edge 219 comprise non-uniform widths. In one example, the first edge 217 and the second edge 219 may be provided with substantially the same shape and size, and, similarly, the projection 270 and the projection 280 may be provided with substantially the same size and shape.

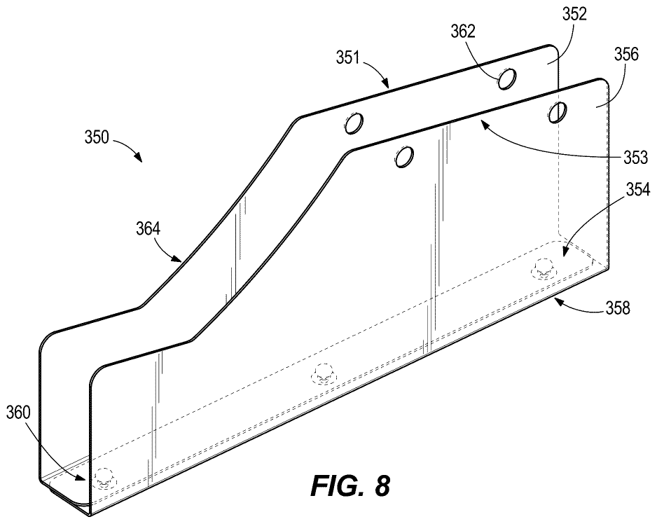

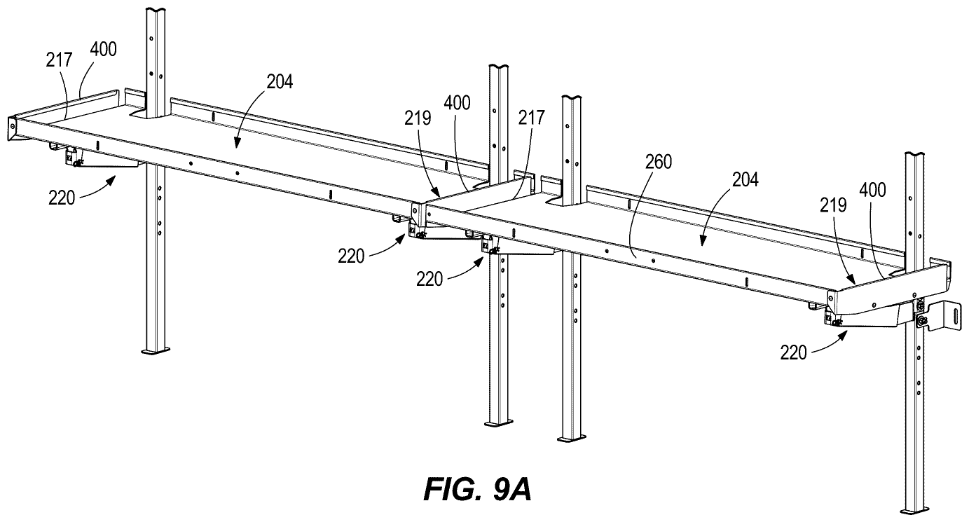

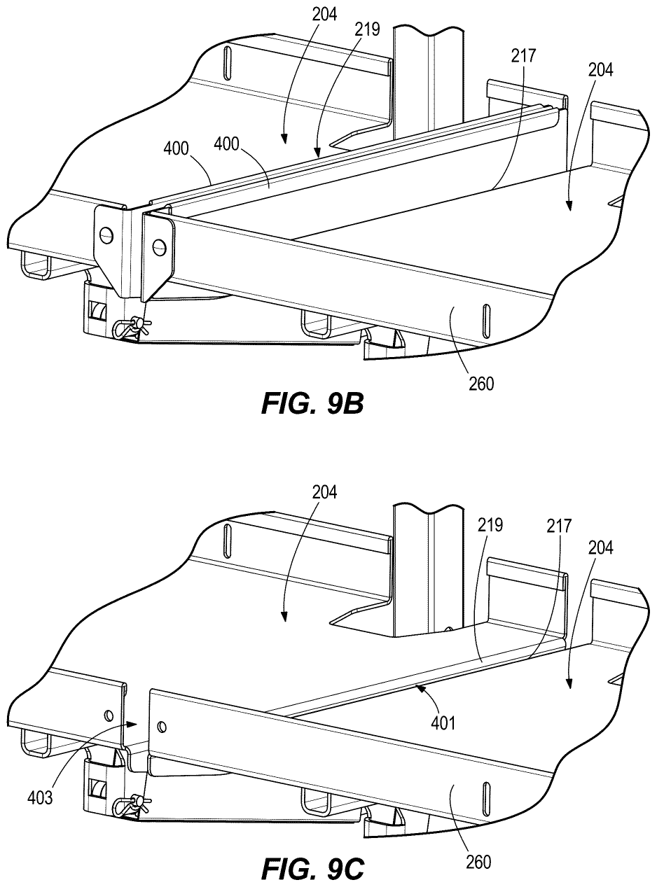

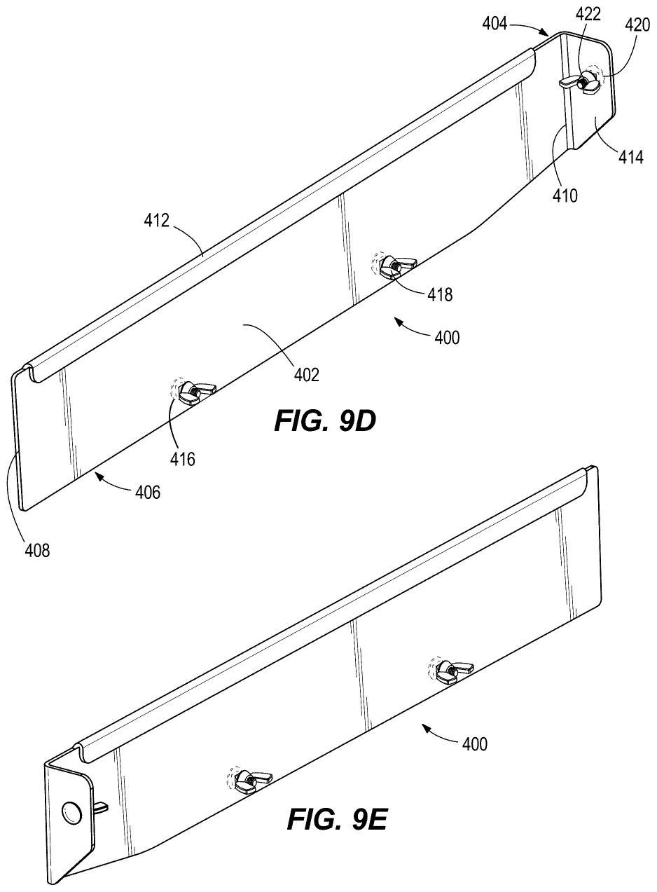

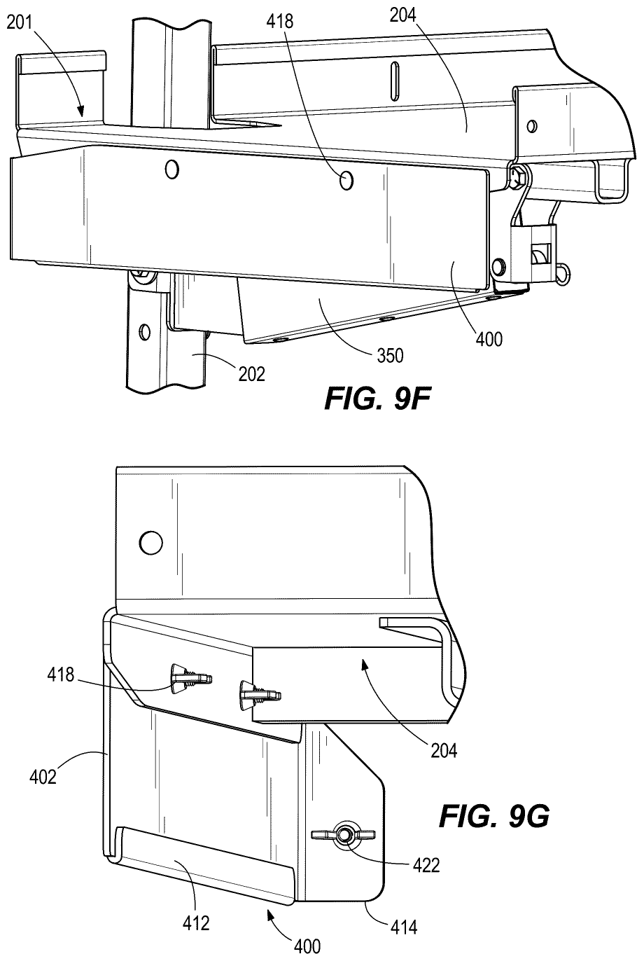

Moreover, the foldable shelving unit 200 may include any number of shelves 204. In one example, as shown in FIGS. 1A and 1B, the foldable shelving unit 200 may include one shelf 204 (i.e., a first shelf 204 with a first support unit 220 securing the first shelf 204 to the support beam 202) positioned above another shelf 204 (i.e., a second shelf 204 with a second support unit 220 securing the second shelf 204 to the support beam 202), whereas, in another example, as shown in FIG. 9A, the foldable shelving unit 200 may include one shelf 204 (i.e., a first shelf 204 with a first support unit 220 securing the first shelf 204 to the support beam 202) positioned next to (or substantially adjacent to) another shelf 204 (i.e., a second shelf 204 with a second support unit 220 securing the second shelf 204 to the support beam 202) such that the shelves 204 (i.e., the first and second shelves 204) are substantially axially aligned on a horizontal plane in the use position 213.

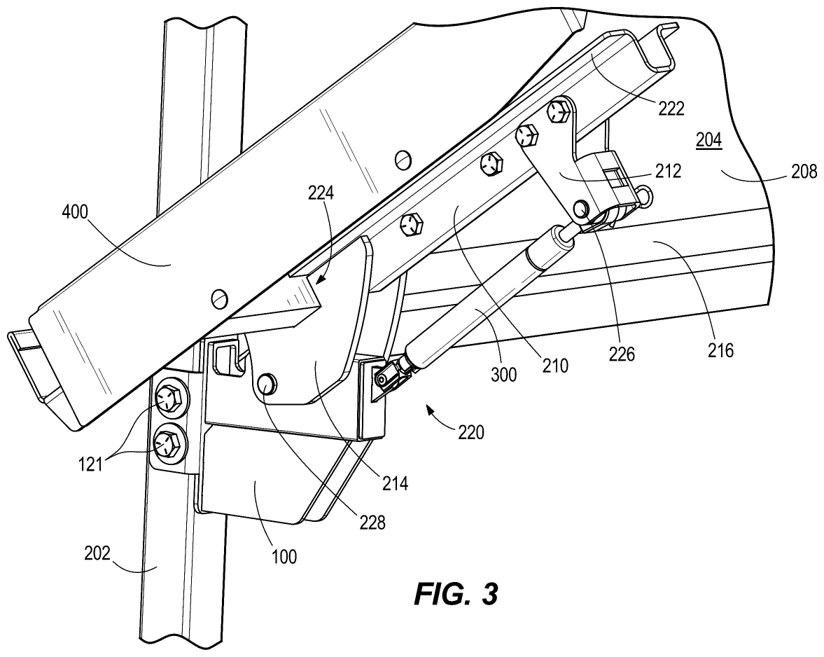

Continuing with FIG. 3, the at least one support unit 220 of the foldable shelving unit 200 is coupled to the bottom surface 208 of the shelf 204 securing the shelf 204 to the support beam 202 and facilitating movement of the shelf 204 between the use position 213 and the stowed position 215. In one example, the support unit 220 may include a pivot block 100 that may be removably coupled to the support beam 202, a hinge 214 to facilitate rotating the shelf 204, a support member 210, a bracket 212, a spring 300 designed to facilitate movement of the shelf 204 between the use position 213 and the stowed position 215, and an optional cover 350 designed to cover the spring 300. In other examples, the support unit 220 may have greater or fewer components than shown in the figures and discussed herein.

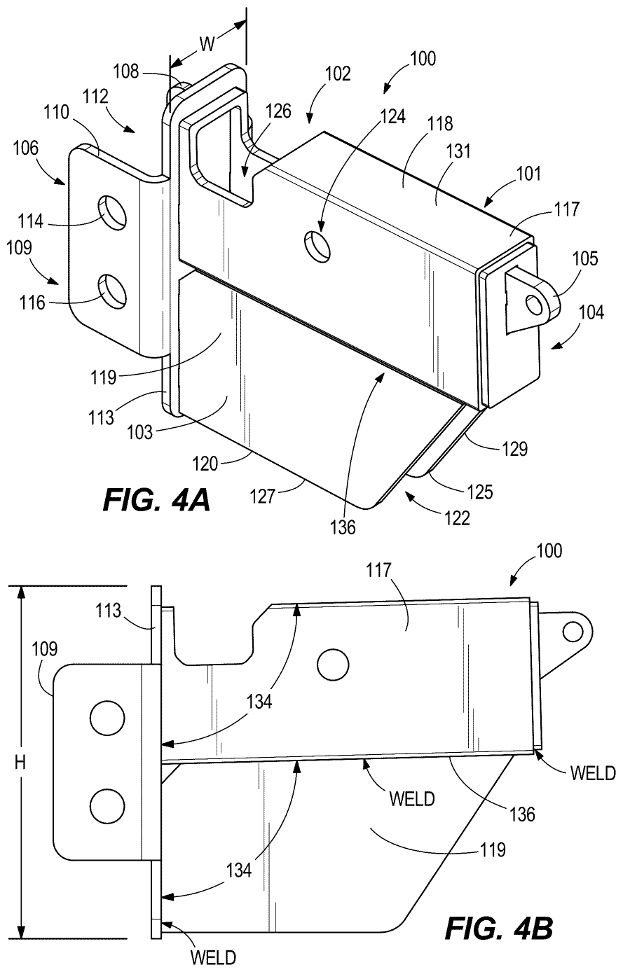

Turning to FIGS. 4A and 4B, one implementation of the pivot block 100 of the support unit 220 is shown. The pivot block 100 is designed to transfer the shelf load from the shelf 204 to the support beam 202. The pivot block 100 includes a body 102 having a first end 104 and a second end 106. The body 102 also may include a first face 101 and a second face 103 opposite the first face. In one example, the second face 103 may generally be a mirror image of the first face 101. In other examples, the second face 103 may be different than the first face 101.

The first end 104 of the pivot block 100 has a first securing portion 105 coupled (e.g., welded) to the body 102. In one example, the first securing portion 105 is provided in the form of a protrusion with an aperture formed therein. The first securing portion 105 is configured to be secured to a spring, such as the gas spring 300 (shown in at least FIG. 3), which will be described in more detail herein. Any suitable fastening mechanism may be used to secure the first end 104 of the pivot block 100, via the first securing portion 105, to the gas spring 300. The first securing portion 105 allows for an over-center design that holds the shelf 204 in both the stowed position 215 and the use position 213. An over-center spring design is one in which the spring force of the gas spring 300 switches the direction it acts upon an object as the spring crosses a neutral axis. This causes the spring 300 to push the shelf 204 in a downward direction when the shelf 204 is in the use position 213, and then change to push the shelf 204 in an upward direction when the shelf 204 is moved (e.g., rotated upward) to the stowed position 215. In another example, the first end 104 does not include the first securing portion 105. In such an example, the gas spring 300 may be coupled to directly to the first end 104 of the pivot block 100.

The second end 106 of the pivot block 100 has a second securing portion 109 coupled (e.g., welded) to the body 102. The second securing portion 109 is generally U-shaped (or any suitable shape) and may be provided with a size and shape to engage at least a portion of the support beam 202. Thus, as shown in FIG. 4A, the second securing portion 109 may include one or more outwardly extending projections 108, 110 separated by a space 112, and connected by an upwardly extending wall 113. In one example, the upwardly extending wall 113 has a substantially rectangular shape and a substantially constant thickness; however, in other examples, the upwardly extending wall 113 may include a thickened area used to withstand stresses experienced when the shelf 204 is in the stowed position 215 and further may have any suitable shape. Additionally, the upwardly extending wall 113 may have a height H that is greater than a height of the body 102 of the pivot block 100, and the upwardly extending wall 113 may have a width W that is greater than a width of the body 102 of the pivot block 100.

Continuing with the second securing portion 109, in one example, each projection 108, 110 is provided with one or more apertures 114, 116 configured to engage or receive one or more fastening mechanisms 121 (shown in FIG. 2), such as a bolt or another suitable mechanism. The fastening mechanisms 121 may facilitate coupling the second securing portion 109 of the pivot block 100 to the support beam 202. Thus, the space 112 of the second securing portion 109 may be sized to be substantially the same size or slightly larger than the support beam 202 to provide a secure, flush fit between the second securing portion 109 of the body 102 and the support beam 202. Moreover, when the second securing portion 109 is coupled to the support beam 202, the upwardly extending wall 113 may engage at least one surface of the support beam 202.

Continuing with FIGS. 4A and 4B, the body 102 of the pivot block 100 may include an indentation 126, a top surface or top edge 118, at least one bottom edge 120, a space 122 located between the first face 101 and the second face 103, and a pivot point 124.

The top surface 118 may have the indentation 126 formed therein. The indentation 126 may be provided with a substantially rectangular shape and may be provided with a size to receive at least a portion of the hinge 214 therein when the shelf 204 is in the stowed position 215. In one example, the indentation 126 is formed near or adjacent the upwardly extending wall 113 of the second securing portion 109.

The top surface 118 further may include a substantially flat surface or flat portion 131 that contacts the shelf 204 in the use position 213, and the top surface 118 may extend between the first face 101 and the second face 103. The flat surface 131 is designed to transfer the shelf load into the support beam 202 to which the pivot block 100 is fastened. As shown in FIG. 4B, the flat surface 131 may be provided at an angle 134 with respect to the upwardly extending wall 113 and/or the support beam 202. In one example, the angle 134 is between about 60 degrees and about 120 degrees, or between about 80 degrees and 100 degrees, or about 91.5 degrees. The angle 134 translates to a shelf resting angle 221 (shown in FIG. 2), discussed herein. The angle 134 is provided so that when the shelf 204 is in the stowed position 215 (e.g., the shelf 204 is resting on the top surface 118 of the pivot block 100), at least one surface of the shelf 204 is angled (e.g., slightly) or biased toward the support beam 202 or the interior wall of the vehicle. The angle 134 and/or the angle 221 is provided so that an object on the shelf 204 (e.g., when the object is subjected to vibration or bouncing) is more likely to slide or lean toward the first end 201 of the shelf 204 as opposed to sliding toward (e.g., or fall off of) the second end 203 of the shelf 204.

In one implementation, the bottom edge(s) 120 of the first face 101 and the second face 103 may have a first linear portion 127 and a second linear portion 129 with a curved portion 125 between the linear portions 127, 129. In other embodiments, the top surface 118 and bottom edge(s) 120 may be provided with alternate shapes or at alternate angles.

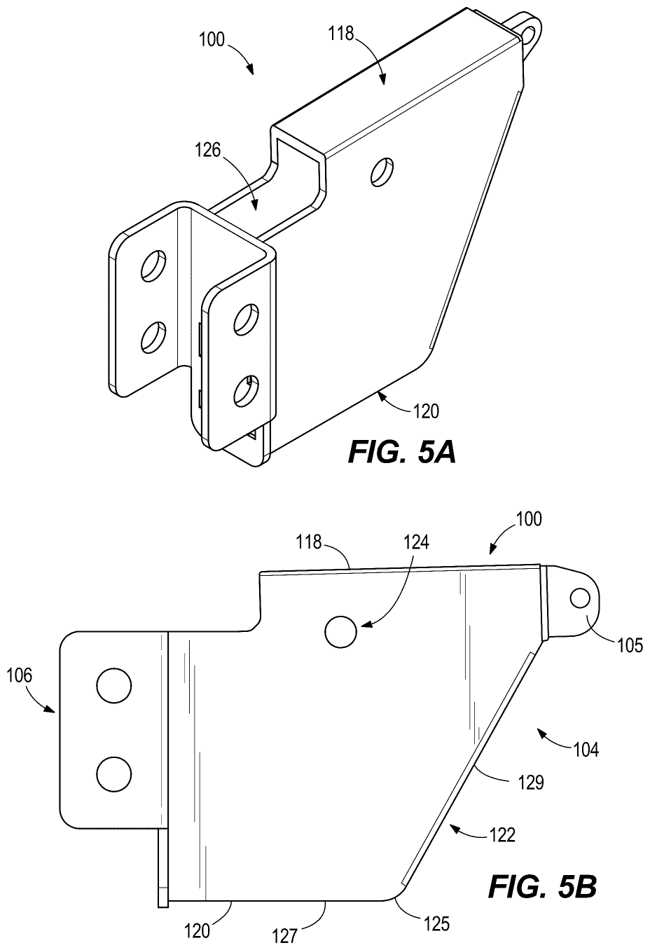

The body 102 of the pivot block 100 may also include a pivot point 124. As shown in FIGS. 4A, 4B, 5A, and 5B, the pivot point 124 may be provided at or near the top surface 118; however, in other examples, the pivot point 124 may be positioned anywhere within the body 102. The pivot point 124 may be provided in the form of a pair of openings, wherein a first opening (not shown) may be formed in the first face 101 and a second opening (e.g., axially aligned with the first opening) may be formed in the second face 103. In other examples, the pivot point 124 may include one opening formed in either the first face 101 or the second face 103. The pivot point 124 is configured to facilitate connecting the pivot block 100 to the hinge 214 (discussed herein) and facilitates moving the shelf 204 between the use position 213 and the stowed position 215. Although the opening of the pivot point 124 is shown as being circular, the opening may be provided in the form of other suitable shapes in alternate examples.

Moreover, continuing with the body 102 of the pivot block 100, in one example (shown in FIGS. 4A and 4B), the body 102 includes an upper portion 117 and a lower portion 119 provided separately from the upper portion 117. In an example implementation, the upper portion 117 and the lower portion 119 are coupled (e.g., welded) together with a surface 136 therebetween. Providing at least two (e.g., separate) portions 117 and 119 facilitates providing the body 102 with enough strength to withstand the load of at least one shelf 204.

The upper portion 117 is shown in FIG. 4A with a substantially rectangular shape; however, the upper portion 117 may be provided with any suitable shape. In an example implementation, the upper portion 117 is formed from a (e.g., rectangular) stock size tube to simplify manufacturing of at least a portion of the body 102.

Further, the lower portion 119 may be provided as a pair of flanges with the surface 136 extending therebetween. In one example, the surface 136 forms the angle 134 with the upwardly extending wall 113 and/or forms the angle 134 with the support beam 202.

In one example, the upper portion 117 and the lower portion 119 have substantially the same width.

In another implementation (shown in FIGS. 5A and 5B) of the body 102 of the pivot block 100, the upper portion 117 and the lower portion 119 are provided as a unitary structure.

In continuing with the support unit 220, the support unit 220 also includes the support member 210 (shown in at least FIG. 3). The support member 210 is designed to be secured to the shelf 204 with one or more fasteners. It should be understood that any suitable fastening means could be used to secure the support member 210 to the shelf 204. In one example, a plurality of fasteners couple the support member 210 to the shelf 204. The support member 210 is a structural member which supports the shelf load.

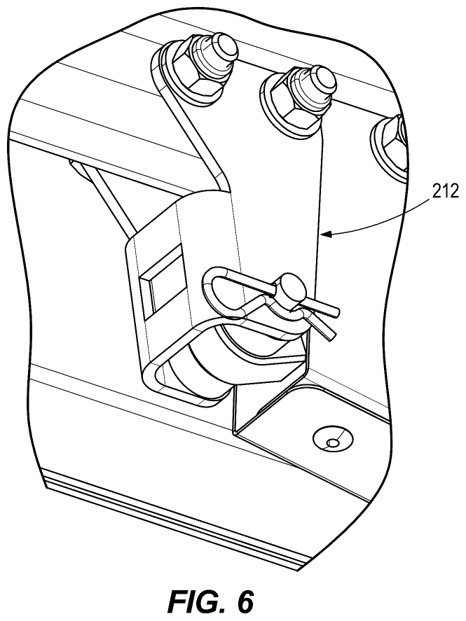

Turning to FIG. 6, the bracket 212 of the support unit 220 of the foldable shelving unit 200 is shown. The bracket 212 may secure the gas spring 300 to the support member 210 or the shelf 204 with at least one fastening mechanism 226, such as a clevis pin with a hairpin cotter or another suitable mechanism. In one example, the bracket 212 positions the gas spring 300 a set distance from the support member 210 or the shelf 204 or at an angle with respect to the support member 210 or the shelf 204, so that the bracket 212 does not interfere with the support member 210 or the shelf 204 during rotation of the shelf 204. It should be understood that any suitable spring may be used in place of or in combination with the gas spring 300.

As best shown in FIG. 3, the gas spring 300 of the support unit 220 of the foldable shelving unit 200 is readily accessible for ease of replacement. The gas spring 300 is configured to control movement of the shelf 204 by slowing the movement of the shelf 204 when being raised into the stowed (e.g., folded) position 215 and when being lowered into the use (e.g., unfolded) position 213. The gas spring 300 further facilitates preventing the shelf 204 from falling when in the stowed position 215, and from moving upward to the stowed position 215 when in the use position 213. In one example, the bracket 212 is not present and the gas spring 300 may be directly connected to the support member 210 or directly connected to the shelf 204.

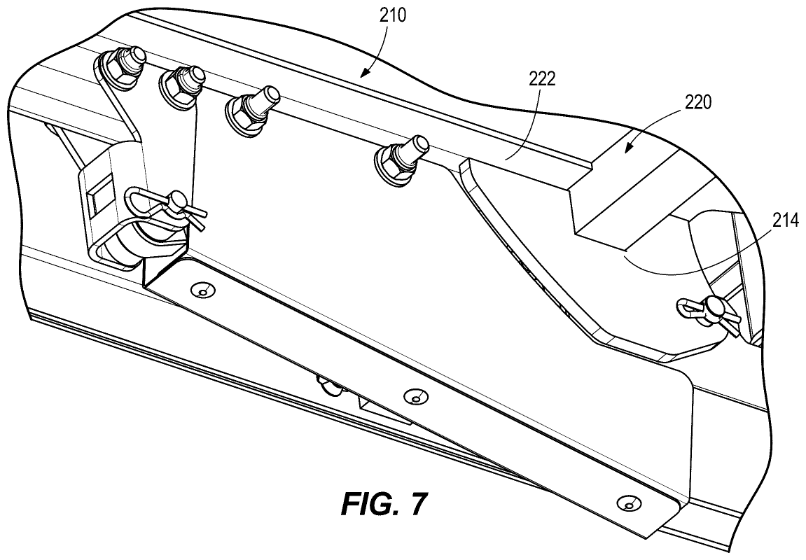

Turning to FIG. 7, in one example, the support unit 220 includes the hinge 214. Moreover, the hinge 214 of the support unit 220 of the foldable shelving unit 200 is designed to secure the pivot block 100 to the support member 210 or the shelf 204. The hinge 214 pivots (along pivot point 124 of the pivot block 100) to move the shelf 204 between the use position 213 and stowed position 215. In one example, the hinge 214 is coupled between the pivot block 100 and a bottom 222 of the support member 210. In another example, the hinge 214 may be secured to the bottom surface 208 of the shelf 204 with any suitable fastening mechanism. In one example, the hinge 214 is secured to the pivot block 100 with a fastening mechanism 228, such as a clevis pin with a hairpin cotter or another suitable mechanism. Moreover, the hinge 214 may have an indentation 224 (e.g., with a substantially rectangular shape or any other suitable shape) to accommodate an optional cross beam 216 (e.g., when the shelf 204 is in the stowed position 215) secured to the bottom surface 208 of the shelf 204 for additional support of the shelf load.

Turning to FIG. 8, in one example, the support unit 220 may include an optional cover 350 designed to cover at least a portion of the spring 300 to protect the spring 300 from debris or damage. The cover 350 may have a first portion 351 having a first wall 352 with a first ledge 354 and a second portion 353 having a second wall 356 with a second ledge 358. Each ledge 354 and 358 may include at least one aperture 360. The first portion 351 and the second portion 353 may be coupled together by aligning at least one aperture 360 of the first ledge 354 with at least one aperture 360 of the second ledge, so that the first ledge 354 and the second ledge 358 overlap. Each aperture 360 is designed to accommodate a fastening mechanism therein to facilitate coupling the first ledge 354 and the second ledge 358 together to form the cover 350. Additionally, at least one of the first wall 352 and the second wall 356 may include an aperture 362 designed to accommodate a fastening mechanism therein to facilitate coupling the first wall 352 and/or the second wall 356 to at least a portion of the support member 210. Moreover, in one example, the first wall 352 and/or the second wall 356 may have a cut-out portion 364 to prevent interference with the hinge 214 when the cover 350 is installed, as shown in FIGS. 1A, 2, and 6.

As mentioned herein, the foldable shelving unit 200, in addition to the shelf 204 and the support unit 220, may include at least one optional removable end cap 400 designed to (e.g., extend a distance upward from the top surface 206 of the shelf 204 to) prevent objects from sliding off the shelf 204 when the shelf 204 is in use. In one example, the end cap 400 is coupled to the shelf 204. At least one end cap 400 (e.g., the end cap 400, such as a right end cap 400, shown in FIG. 9D) may be coupled to the projection 270 of the shelf 204, and/or at least one end cap 400 (e.g., the end cap 400, such as a left end cap 400, shown in FIG. 9E) may be coupled to the projection 280 of the shelf 204. The removable end cap 400 may be provided in the form of aluminum or any other suitable (e.g., lightweight yet sturdy) material.

Turning to FIGS. 9A through 9E, the removable end cap 400 may have a body 402 with a substantially rectangular shape, such that the body 402 extends between a top edge 404 and an opposing bottom edge 406, and a first side edge 408 and an opposing side edge 410. In one example, the body 402 is provided with a shape that is substantially the same shape as that of the projection 270 and/or the projection 280 of the shelf 204; however, the body 402 may be designed with any suitable shape. In one example, the body 402 of the end cap 400 may have a length that is (e.g., slightly) shorter than the length of the projection 270 and/or projection 280. Moreover, in one example, the body 402 may have at least one aperture 416 formed therein, wherein the aperture 416 is near the (bottom) edge 406 and is designed to receive a fastening mechanism 418 therein to facilitate coupling the end cap 400 to (e.g., the projection 270 and/or the projection 280 of) the shelf 204. In one example, the fastening mechanism 418 may be a (e.g., stainless steel) screw and screw wing bolt or may be another suitable fastening mechanism. The fastening mechanism 418 may facilitate a user being able to easily install and uninstall the end cap 400 by hand. Further, when the body 402 is coupled to at least one projection 270, 280 of the shelf 204 with at least one fastening mechanism 418, the end cap 400 is designed to prevent interference with the support beam 202 when the shelf is in the use position 213 or the stowed position 215.

Additionally, the body 402 of the end cap 400 may include a protrusion 414 (e.g., that is substantially perpendicular to the body 402) designed to engage at least a portion of the flange 260 of the second end 203 of the shelf 204. The protrusion 414 may extend outward from the edge 408 and/or the edge 410 of the body 402 and the protrusion 414 may include an aperture 420 therein, wherein the aperture 420 is designed to receive a fastening mechanism 422 to facilitate coupling the end cap 400 to the shelf 204. In one example, the fastening mechanism 422 may be a (e.g., stainless steel) screw and screw wing bolt (e.g., to be easily installed or uninstalled by hand) or may be another suitable fastening mechanism. Moreover, to couple the end cap 400 to the shelf 204, the aperture 420 of the protrusion 414 of the end cap 400 may be configured to align with the aperture 262 of the second flange 260 of the shelf 204 and the fastening mechanism 422 may be inserted through both apertures 420 and 262.

Moreover, at least one edge, preferably the top edge 404, of the end cap 400 may include a flange 412. The flange 412 may be curved, so that the top edge 404 does not have a sharp edge.

In use, the foldable shelving unit 200 is provided to be easily assembled with any number of shelves 204 and is further provided to prevent pinch points from forming when the foldable shelving unit 200 is in use.

When the foldable shelving unit 200 is in the use position 213, a user may store various objects on at least one shelf 204. It is noted that in the use position 213, the top surface 206 of the shelf 204 forms the angle 221 (e.g., shelf resting angle) (shown in FIG. 2) with respect to the support beam 202, such that the angle 221 in the use position 213 may be less than about 90 degrees, or between about 60 degrees and about 90 degrees, or about 88.5 degrees. When the shelf 204 is no longer in use, a user may lift the shelf 204 upwardly toward the wall of the vehicle (or toward the support beam 202), which releases the gas spring 300. This causes the hinge 214 to rotate about the pivot point 124 of the pivot block 100. Thus, once in the stowed position 215, the shelf 204 is in a substantially vertical position, and the weight of the shelf 204 is transferred from the support member 210 to the pivot block 100 and/or the support beam 202. The second end 203 of the shelf 204 is held near (e.g., against) the support beam 202 by the spring force from the gas spring 300 when in the stowed position 215. The weight of the shelf 204 is supported through the hinge 214 at the pivot point 124 when in the stowed position 215. In the stowed position 215, the angle 221 between the top surface 206 of the shelf 204 and the support beam 202 is less than the angle 221 when the shelf 204 is in the use position, such that the angle 221 in the stowed position may be between about 5 degrees and about 80 degrees, or less than about 20 degrees, or between about 10 degrees and about 20 degrees, or about 15 degrees. The notch 209 allows the shelf 204 to move into the stowed position 215 without interference from the support beam 202. Additionally, the indentation 126 allows the hinge 214 to move into the stowed position 215 without interference from the pivot block 100. Once in the stowed position 215, the gas spring 300 prevents the shelf 204 from falling back into the use position.

To move the shelf 204 back into the use position 213, a user pushes down on the shelf away from the wall of the vehicle or away from the support beam 202, which releases the gas spring 300. The hinge 214 then rotates about the pivot point 124 of the pivot block 100 and the shelf 204 continues to move downward into the use position 213. Once in the use position 213, the shelf 204 rests on the top surface 118 of the pivot block 100, and the gas spring 300 prevents the shelf 204 from moving upward into the stowed position 215. Also, in the use position 213, the shelf 204 rests at the angle 221 (e.g., of about 88.5 degrees) with respect to the support beam 202.

Further, in use, as shown in FIGS. 1A, 1B, 3, 9A, and 9B, the foldable shelving unit 200 may include at least one removable end cap 400. The end cap 400, when installed, is designed to prevent objects on the shelf 204, when the shelf 204 is in the use position 213, from sliding off (e.g., the end of) the shelf 204. Also, when installed, the body 402 of the end cap 400 is coupled to the shelf 204 with at least one of the fastening mechanisms 418, 422, such that the body 402 of the removable end cap 400 extends upward from at least one surface of the shelf 204 and the protrusion 414 is at or near the second end 203 of the shelf 204.

FIG. 9A has two substantially adjacent shelves 204, both in the use position 213. In one example, the one shelf 204 has the end cap 400 on the first edge 217 and another end cap 400 on the second edge 219, whereas the adjacent shelf 204 is provided with (e.g., only) one end cap 400 on the second edge 219.

FIG. 9B has two substantially adjacent shelves 204, both in the use position 213. In one example, the one shelf 204 has one end cap 400 on the second edge 219 and the other shelf 204 has one end cap 400 on edge 217. As shown, there is a space 401 (FIG. 9C) between the shown end caps 400, to prevent interference of the end caps 400 with one another and to further facilitate independent operation of each shelf 204.

FIG. 9C has the shelving unit 200 without the removable end cap 400 so that there is no raised component between two substantially adjacent shelves 204, when in the use position 213. There is a space 403 between the substantially adjacent shelves 204 to allow an object on one shelf to be slid to another adjacent shelf without having to pick up the object and move it (e.g. over an end cap or a raised edge) to an adjacent shelf. The space 403 is sized to allow an object to be slid from one shelf to another and also is sized such that an object will not fall into the space 403 when the object is moved.

Each end cap 400 is designed to be installed and uninstalled by hand. Moreover, as shown in FIGS. 9F and 9G, when the (e.g., left) removable end cap 400 is not in use, the user can store the removable end cap 400 and/or the associated fastening mechanisms 418, 422 by coupling the removable end cap 400 to the shelf 204 to prevent loss or misplacement of the removable end cap 400 and/or the at least one of the fastening mechanisms 418, 422. In one example implementation, the removable end cap 400 can be stored (e.g., in a storage position) by coupling the removable end cap 400, with at least one of the fastening mechanisms 418, 422, to the shelf 204 such that the body 402 of the removable end cap 400 extends downward from at least one surface of the shelf 204 and the protrusion 414 is at or near the first end 201 of the shelf 204. When the removable end cap 400 is in the storage position, objects may be able to slide between shelves 204 without interference.

While some embodiments have been illustrated and described in detail in the appended drawings and the foregoing description, such illustration and description are to be considered illustrative and not restrictive. Other variations to the disclosed embodiments can be understood and effected in practicing the claims, from a study of the drawings, the disclosure, and the appended claims. The mere fact that certain measures or features are recited in mutually different dependent claims does not indicate that a combination of these measures or features cannot be used. Any reference signs in the claims should not be construed as limiting the scope.

What is claimed is:

1. A foldable shelving unit comprising:
a shelf having a top surface and a bottom surface; and
at least one support unit to secure the shelf to a support beam, wherein the at least one support unit includes:
a bracket including a first end secured to the shelf and a second end secured to a spring,
a hinge coupled to at least one of the bottom surface of the shelf, and
a pivot block, wherein the pivot block includes:
a body having a first end, a second end, and a top surface,
a first securing portion coupled to the first end of the pivot block, the first securing portion configured to be secured to the spring,
a second securing portion coupled to the second end of the pivot block, the second securing portion configured to be secured to the support beam, and
a pivot point located within the body, wherein the hinge is secured to the bottom surface of the shelf and to the pivot point of the pivot block,
wherein the spring is configured to facilitate the shelf pivoting at the pivot point between a first position and a second position,
wherein at least a portion of the bottom surface of the shelf is configured to rest on the top surface of the body of the pivot block when the shelf is in the first position.

2. The foldable shelving unit of claim 1, further comprising at least one removable end cap designed to be coupled to the shelf.

3. The foldable shelving unit of claim 1, further comprising at least one removable cover designed to cover at least a portion of the spring.

4. The foldable shelving unit of claim 1, further comprising a cross beam secured to the bottom surface of the shelf.

5. The foldable shelving unit of claim 1, wherein the shelf comprises a notch, the notch being configured to accommodate the support beam when the shelf is in at least one of the first position and the second position.

6. The foldable shelving unit of claim 1, wherein the support beam is mounted to an interior wall of a vehicle.

7. The foldable shelving unit of claim 1, wherein the top surface of the shelf forms an angle of less than about 90 degrees with the support beam when the shelf is in the first position.

8. A foldable shelving unit comprising:
a support beam;
a shelf attached to the support beam and including a support surface;
at least one support unit to secure the shelf to the support beam, wherein the at least one support unit includes:
a spring configured to facilitate movement of the shelf between a first position and a second position,
a bracket including a first end secured to the shelf and a second end secured to the spring,
a hinge coupled to the shelf, and
a pivot block including a first end secured to the spring, a second end secured to the support beam, and a pivot point configured to connect the pivot block to the hinge; and
an end cap removably couplable to the shelf in a first position in which at least a portion of the end cap projects above the support surface and a second position in which the end cap is stored below the support surface,
wherein the hinge is pivotable about the pivot point to move the shelf between the first position and the second position.

9. The foldable shelving unit of claim 8, wherein the shelf is configured to rest along the pivot block when the shelf is in the first position.

10. The foldable shelving unit of claim 8, wherein the shelf has a notch, the notch being configured to accommodate the support beam when the shelf is in at least one of the first position and the second position.

11. The foldable shelving unit of claim 8, wherein the support beam is mounted to an interior wall of a vehicle.

12. The foldable shelving unit of claim 8, wherein the shelf forms an angle of less than about 90 degrees with the support beam when the shelf is in the first position.

13. A foldable shelving unit comprising:
a support beam;
a shelf attached to the support beam and including a support surface;
at least one support unit to secure the shelf to the support beam, wherein the at least one support unit includes:
an over-center spring configured to facilitate movement of the shelf between a first position and a second position and including a first end and a second end,
a bracket including a first end secured to the shelf and a second end secured to the first end of the over-center spring,
a hinge coupled to the shelf, and
a pivot block including a first end secured to the second end of the over-center spring, a second end secured to the support beam, and a pivot point positioned between the first end of the pivot block and the second end of the pivot block configured to connect the pivot block to the hinge; and
wherein the hinge is pivotable about the pivot point to move the shelf between the first position and the second position.

14. The foldable shelving unit of claim 13, wherein the shelf is configured to rest along the pivot block when the shelf is in the first position.

15. The foldable shelving unit of claim 13, wherein the shelf has a notch, the notch being configured to accommodate the support beam when the shelf is in at least one of the first position and the second position.

16. The foldable shelving unit of claim 13, wherein the support beam is mounted to an interior wall of a vehicle.

17. The foldable shelving unit of claim 13, wherein the support surface of the shelf forms an angle of less than about 90 degrees with the support beam when the shelf is in the first position.

18. The foldable shelving unit of claim 13, further comprising an end cap removably couplable to the shelf in a first position in which at least a portion of the end cap projects above the support surface and a second position in which the end cap is stored below the support surface.

19. The foldable shelving unit of claim 13, wherein over-center spring is a gas spring.

20. The foldable shelving unit of claim 13, wherein the second end of the over-center spring is positioned between the first end of the over-center spring and the pivot point.
